(19) United States
(12) Patent Application Publication
(10) Pub. No.: US 2023/0259212 A1
(43) Pub. Date: Aug. 17, 2023

(54) 3-D Printable Multi-Degrees-Of-Freedom Haptic Interfaces for Stimulating Skin Strech, Pressure and Vibrotactile Feedback on a User's Body

(71) Applicant: The Board of Trustees of the Leland Stanford Junior University, Stanford, CA (US)

(72) Inventors: Zhenishbek Zhakypov, Mountain View, CA (US); Allison M. Okamura, Mountain View, CA (US)

(21) Appl. No.: 18/109,417

(22) Filed: Feb. 14, 2023

Related U.S. Application Data
(60) Provisional application No. 63/309,862, filed on Feb. 14, 2022.

(51) Int. Cl. G06F 3/01; B29C 64/106; B06B 1/18

(52) U.S. Cl. CPC G06F 3/016; B06B 1/18; B29C 64/106

(57) ABSTRACT

A fully 3-D printed, soft, monolithic 4-DoF fingertip haptic technology is provided, called FingerPrint, that stimulates linear and rotational shear, pressure, and vibration on the fingerpad. Constructed using an origami waterbomb base mechanism and printed from a flexible material, the device embeds four sets of eight foldable vacuum-powered pneumatic actuators to achieve three translational (x, y, z) and one rotational (torsion) tactile motions and forces of a tactor end-effector on the fingerpad skin.

### CROSS-REFERENCE TO RELATED APPLICATIONS

This application claims priority from U.S Provisional Pat. Application 63/309862 filed Feb. 14, 2022, which is incorporated herein by reference.

### STATEMENT OF GOVERNMENT SPONSORED SUPPORT

This invention was made with Government support under contract 1812966 awarded by the National Science Foundation, and under contract 1830163 awarded by the National Science Foundation. The Government has certain rights in the invention.

### FIELD OF THE INVENTION

This invention relates to method, devices and system for generating haptic feedback.

### BACKGROUND OF THE INVENTION

Wearable fingertip haptic devices can be used to generate realistic touch experiences in Virtual, Augmented, and Mixed Reality. Haptic (touch-based) feedback is a key component of the sensorimotor experience, yet in consumer devices, haptic stimuli are typically limited to simple vibrations used as event alerts that call the attention of the user, rather than improve immersion or increase the information transfer rate.

Haptic perception is critical to how we perceive the physical properties of objects and the environment. Thousands of mechanoreceptors within the fingerpads capture a wide range of information by skin deformation, such as shear, pressure, and vibration, to distinguish various object features through exploratory procedures. For example, one can apply pressure to an object with the index finger and thumb to determine its stiffness, lift and turn it in the air to determine its weight and rotational inertia, and slide the fingertips on its surface to feel its friction, texture, and contours. Engineering a versatile, compelling, and safe haptic interface for rendering such complex interactions at the fingertip is a significant design challenge.

Conventional robot designs incorporate motors, transmission elements, rigid links, joints, and other mechanical components. This requires a multitude of elements integrated into a compact and lightweight design to enable force feedback by multi-Degrees-of-Freedom (DoF) fingerpad skin deformations. Downsizing conventional electromagnetic actuators, e.g., direct current (DC) motors, coupled with gear trains for producing forces on the order of Newtons is unfeasible. The classical joints that combine two or more kinematic pairs, such as pin-hole, ball-socket, and slider- slot, further hinder miniaturization, manufacturing, and assembly.

Existing designs for multi-DoF fingertip haptic interfaces have integrated standard components, resulting in relatively bulky and complex construction and high cost. Some of these devices considerably reduce the DoFs or rely only on the limited modality of feedback by vibrotactile illusions, neglecting the wide variety of possible tactile stimuli. Recent studies on foldable mechanisms using compliant joints and multi-layer composite fabrication techniques present opportunities for multifunctional yet compact fingertip tactile interface designs. However, these prototypes still employ off-the-shelf electromagnetic or piezoelectric motors that limit miniaturization and require complex manual assembly processes.

Alternatively, additive manufacturing through multimaterial three-dimensional (3-D) printing offers high freedom and speed for fabricating complex soft and compliant mechanical structures, actuators, and mechanisms, ideally with the push of a button. Proposed 3-D printed fingertip haptic prototypes provide stimuli by single or distributed one-DoF inflatable actuators for simple interaction. Despite its potential, little research has been conducted into 3-D printing technology for multi-DoF mesoscale haptic interfaces.

### SUMMARY OF THE INVENTION

With this invention, one embodiment of a fully 3-D printed, soft, monolithic 4-DoF fingertip haptic device is provided, called FingerPrint, that stimulates linear and rotational shear, pressure, and vibration on the fingerpad. Constructed using an origami waterbomb base mechanism and printed from a flexible material, the device embeds four sets of eight foldable vacuum-powered pneumatic actuators to achieve three translational (x, y, z) and one rotational (torsion) tactile motions and forces of a tactor end-effector on the fingerpad skin. The tactor produces several millimeters of motion and several newtons of forces in Cartesian coordinates, and several tenths of degrees and several tenths of newton-millimeter torque in rotation (yaw). The soft device readily interfaces with a user’s finger via a soft thimble, which embeds multiple fluidic channels for vacuum supply and enables a gentle and secure interface with the skin. The design and actuation method is scalable and the use of the device can be extended beyond the fingertip for various tactile or physical stimulation of other human body parts, such as wrist, arm, legs, trunk, or face.

Embodiments of the invention creates opportunities for consumer-oriented, medical, and research applications as it provides a wide range of tactile and physical stimulation.

Embodiments of the invention have a high potential for enabling complex haptic interactions in virtual, augmented, and mixed reality environments or Metaverse. The device could be used for professional training of skilled workers and surgeons, for interacting with multi-dimensional digital models and designs, for gaming, entertainment, and for online shopping by allowing the users to feel the physical characteristics of commercial goods.

Another commercial application of the device is in medical rehabilitation, particularly physical and occupational therapy of patients with injuries or medical conditions such as stroke or facial palsy. The device could mechanically interact with the skin and muscles by providing gentle repeated stimulations for sensory-reeducation and neuromuscular retraining.

University and company researchers can potentially utilize the device as a platform for conducting various haptic studies in virtual and augmented environments, for studying human tactile perception and neuroscience, medical rehabilitation, etc.

The technological advantages are of embodiments of the invention are, e.g.:
High number of tactile stimulations;
High and variable output force and motion range;
The ability to 3-D print and reproduce the entire complex device monolithically with minimal assembly effort;
Scalability and customizability.

### DETAILED DESCRIPTION

Other embodiments, further teachings and/or examples related to the invention are described in U.S Provisional Pat. Application 63/309862 filed Feb. 14, 2022, which is incorporated herein by reference in their entirety.

What is claimed is:

1. A method of generating haptic feedback, comprising:
(a) having a monolithically three-dimensionally printed haptic device, wherein the haptic device comprises a plurality of foldable actuators, wherein each of the plurality of foldable actuators is a sealed chamber formed by a plurality of polygon-shaped facets connected with foldable flexure hinges;
(b) having a tactor, being a tactile stimulator element, positioned such that each of the plurality of foldable actuators is capable of physically interacting with the tactor; and
(c) actuating one or more of the plurality of foldable actuators, wherein the actuation causes shape changes to the one or more plurality of foldable actuators, wherein the shape changes produce the physical interaction with the tactor resulting in motion of the tactor to be used as haptic feedback.

2. The method as set forth in claim 1, wherein each of the plurality of foldable actuators comprises tiles or links mechanically interconnected with foldable flexure hinges, joints or one of the foldable actuators.

3. The method as set forth in claim 1, wherein the actuating comprises channels for supplying air or vacuum to the plurality of foldable actuators.

4. A method of printing a haptic device, comprising:
(a) Having a model of the haptic device; and
(b) Monolithically printing the haptic device, wherein the haptic device is a monolithically three-dimensionally printed haptic device comprising:
(i) a plurality of foldable actuators, wherein each of the plurality of foldable actuators is a sealed chamber formed by a plurality of polygon-shaped facets connected with foldable flexure hinges;
(ii) a tactor, being a tactile stimulator element, positioned such that each of the plurality of foldable actuators is capable of physically interacting with the tactor; and
(iii) channels and ports used for actuating the plurality of foldable actuators, wherein the actuation causes shape changes to the plurality of foldable actuators, wherein the shape changes produce the physical interaction with the tactor resulting in motion of the tactor to be used as haptic feedback.
